(19) United States
(12) Patent Application Publication
(10) Pub. No.: US 2013/0035155 A1
(43) Pub. Date: Feb. 7, 2013

(54) AMUSEMENT DEVICE FEATURING VIRTUAL CURRENCY SUPPORT ACROSS MULTIPLE GAMES

(71) Applicant: William L. LAYNE, IV, Langhorne, PA (US)

(72) Inventor: William L. LAYNE, IV, Langhorne, PA (US)

(73) Assignee: AMI ENTERTAINMENT NETWORK, INC., Bristol, PA (US)

(21) Appl. No.: 13/563,821

(22) Filed: Aug. 1, 2012

Related U.S. Application Data
(60) Provisional application No. 61/515,157, filed on Aug. 4, 2011.

(51) Int. Cl. A63F 13/00

(52) U.S. Cl. 463/25

(57) ABSTRACT

An amusement device includes a touchscreen display and an input component that receives value in order to establish one or more playable credits. The one or more credits are used to permit play of at least one of a plurality of electronic games. A controller is configured to (i) select and play the at least one of the plurality of electronic games, (ii) access a first player account having a balance of virtual currency associated therewith, the virtual currency being different than the one or more playable credits and usable with two or more of the plurality of electronic games, and (iii) debit the first player account by a first amount of virtual currency in exchange for use by a first player of a first feature during play of the at least one electronic game.

### CROSS-REFERENCE TO RELATED APPLICATIONS

This application claims the benefit of U.S. Provisional Patent Application No. 61/515.157, filed on Aug. 4, 2011, entitled “Amusement Device Featuring Virtual Currency Support Across Multiple Games,” the entire contents of which are incorporated herein by reference in their entirety.

### BACKGROUND OF THE INVENTION

A preferred embodiment of the present invention relates generally to an amusement device and a method of playing an amusement device, and more particularly, to an amusement device and a method of playing where a player can obtain features for use during play of games using virtual currency associated with a player account.

Amusement devices having electronic games for computers and touchscreen video displays or other types of amusement devices are generally known in the art. Amusement devices, such as game machines, which allow a user to select games from a video display are known in the art, such as those disclosed in U.S. Pat. Nos. 4,856,787 (“Itkis”), U.S. Pat. No. 5,575,717 (“Houriet, Jr., et al.”), and U.S. Pat. No. 5,743,799 (“Houriet, Jr., et al.”), each of which is incorporated herein by reference and shows a touchscreen display for making a game selection from a menu of games. Such game machines or amusement devices typically operate upon input of currency (i.e., coin, token, paper money, voucher, credit/debit cards or the like) and are installed in locations such as bars, restaurants, airports, shopping malls, video arcades, casinos or the like. The game choices may include card games, sports games, games of skill, games of chance, action games, trivia games, or the like.

Some amusement devices permit the player to purchase upgrades, power-ups, extra lives, weapons features, ability features, enhancements, or other features for games played thereon. These purchases are made with cash, typically deducted from the value input into the machine. For example, a player may purchase a special bowling ball for one dollar ($1), which may be debited from five dollars ($5) the user placed into the machine to play the games. Although amusement devices have in recent years been connected to networks, due to the nature of the coin-op industry, cash cannot travel with a player's account. For example, a player cannot put cash into a first operator's machine and use it to purchase features on a second operator's machine. To do so would rob the second operator of revenue. Similarly, amusement devices typically offer free games or free credits as prizes for completing certain tasks in games played on the amusement device. Such a system penalizes the amusement device operators. For example, if the player earns a free game, the amusement device is occupied for free, and the operator is losing an opportunity to collect revenue from another player, the same player continuing to pay for game play or other players who would otherwise be paying to use the amusement device.

It is therefore desirable to provide a way for players to obtain upgrades or other features on any amusement device in the network, but prevent operators of the amusement devices from losing revenue as part of the transaction. It is further desirable to provide players with rewards that do not prejudice the operator of the amusement device.

### BRIEF SUMMARY OF THE INVENTION

Briefly stated, a preferred embodiment of the present invention is directed to an amusement device including a touchscreen display, an input component and a controller, the input component receives value in order to establish a playable credit. The playable credit is used to permit play of an electronic game. The controller is configured to select and play the electronic game, access a first player account having a balance of virtual currency associated therewith, display a first upgrade feature and a second upgrade feature on the touchscreen display, receive a selection of the first upgrade feature from the touchscreen display, and debit the first player account by a first amount of virtual currency in exchange for use of the first upgrade feature during play of the at least one electronic game. The virtual currency is different than the playable credit and is usable with two or more of the plurality of electronic games. The first and second upgrade features provide a first player associated with the first player account with an advantage in the electronic game to collect more virtual currency for the balance of virtual currency associated with the first player account, to gain a higher score in the game being played, to complete an in-game challenge, to lower the difficulty of the game or to make the game more fun for the player.

Another preferred embodiment is directed to a method of playing an amusement device, wherein the amusement device includes a touchscreen display, an input component, a memory and a controller. The memory stores a plurality of electronic games. The method includes receiving, by the input component, value and establishing, by the controller, a playable credit based on the value. The method also includes selecting and playing, by the touchscreen display, an electronic game, accessing a first player account, by the memory, having a balance of virtual currency associated therewith, and debiting, at the memory, the first player account by a first amount of virtual currency in exchange for use by a first player associated with the first player account of a first upgrade feature during play of the at least one electronic game. The virtual currency is different than the playable credit and is usable with two or more of the plurality of electronic games. The playable credit is used to permit play of at least one of the plurality of electronic games. The first upgrade feature provides the first player with an advantage in the electronic game to collect more virtual currency for the balance of virtual currency associated with the first player account, to gain a higher score in the game being played, to complete an in-game challenge, to lower the difficulty of the game or to make the game more fun for the player.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustration, there are shown in the drawings embodiments which are presently preferred. It should be understood, however, that the invention is not limited to the precise arrangements and instrumentalities shown. In the drawings:

FIG. 1A is a front perspective view of an amusement device in accordance with a first preferred embodiment of the present invention;

FIG. 1B is a front perspective view of an amusement device in accordance with a second preferred embodiment of the present invention;

FIG. 1C is a front perspective view of an amusement device in accordance with a third preferred embodiment of the present invention;

FIG. 2 is a screenshot of a game in accordance with a fourth preferred embodiment of the present invention, wherein the screenshot may be displayed on any of the amusement devices of the first, second and/or third preferred embodiments of FIGS. 1A-1C;

FIG. 3 is a screenshot of a token purchase screen in accordance with a fifth preferred embodiment of the present invention, wherein the token purchase screen may be displayed on any of the amusement devices of the first, second and/or third preferred embodiments of FIGS. 1A-1C;

FIG. 4 is a screenshot of a feature selection screen in accordance with a sixth preferred embodiments of the present invention, wherein the feature selection screen may be displayed on any of the amusement devices of the first, second and/or third preferred embodiments of FIGS. 1A-1C;

FIG. 5 is a schematic block diagram of a server in communication with one of the amusement devices of the first, second and/or third preferred embodiments of FIGS. 1A-1C; and

FIG. 6 is a communication sequence diagram between the server of FIG. 5 and one of the amusement devices of the first, second and/or third preferred embodiments of FIGS. 1A-1C.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the apparatus and designated parts thereof. The terminology includes the above-listed words, derivatives thereof, and words of similar import. Additionally, the words “a” and “an”, as used in the claims and in the corresponding portions of the specification, mean “at least one.” Further, the terms “coin” or “currency” should not be construed as limiting and can be used herein to mean all forms of coin and paper currency from any country as well as proprietary tokens, game cards, credit cards, debit cards, chits, or other representative forms of credit and/or payment.

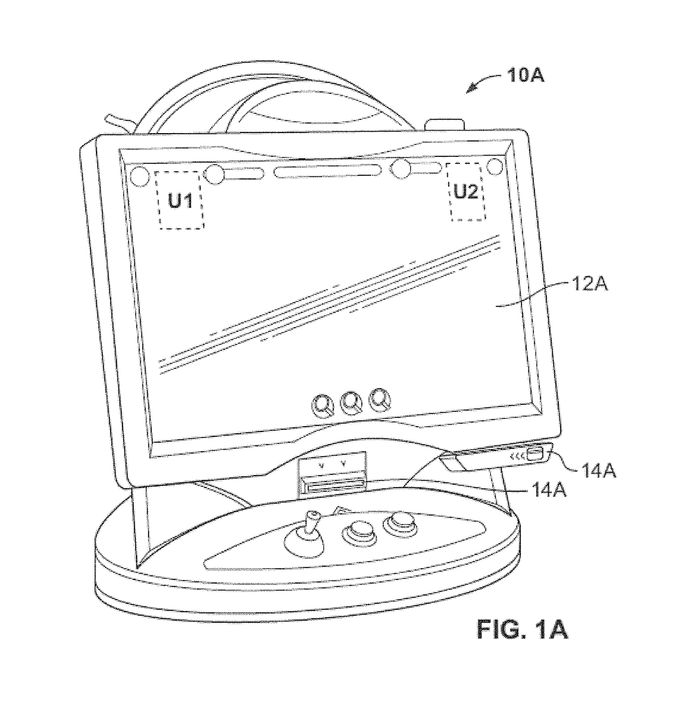

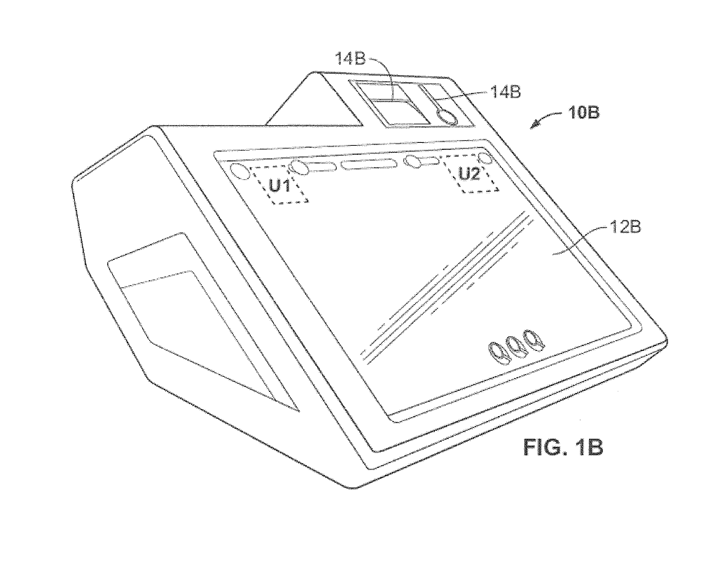

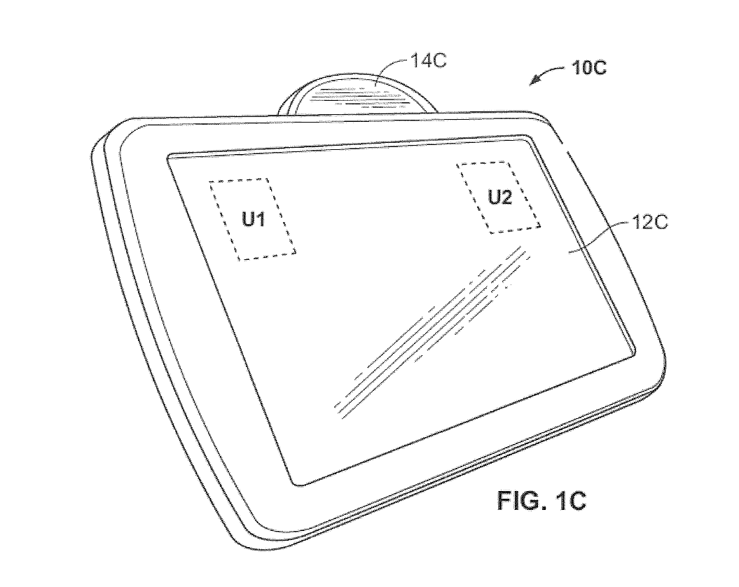

Referring to the drawings in detail, wherein like reference numerals indicate like elements throughout, there is shown in FIG. 1A a first preferred embodiment of an amusement device 10A. The amusement device 10A includes a controller U1 and a memory U2. The memory U2 can be any known or suitable memory device such as random access memory (RAM), read only memory (ROM), flash RAM, hard disk, optical disk, or the like. The amusement device 10A further includes a video display 12A that is operatively connected to the controller U1. In the first preferred embodiment, the video display 12A is comprised of a touchscreen video display or touchscreen display 12A, but is not so limited and may be nearly any variety of video display 12A that is able to display information to a user or player in the normal operating conditions of the first preferred amusement device 10A. The amusement device 10A is preferably a counter-top or table-top apparatus, but may be arranged in any configuration, such as free-standing, floor-standing, table mount, wall mount, pole mount, portable and the like without departing from the preferred embodiment of the invention.

The amusement device 10A of the first preferred embodiment also includes at least one input component 14A that receives value in order to establish one or more playable credits or a playable credit. The value received may be at least one of currency, coins, tokens, chits, credits, credit cards/debit cards or the like. A playable credit may be defined by any value used to describe the cost of playing or accessing application programs, such as electronic games, on the amusement device 10A and is used to permit play of the electronic game. The amount of playable credits received as a result of a particular value is preferably determined or established by the controller U1. Although two input components 14A are shown, the amusement device 10A may include any number of input components 14A to give a player an option for payment, for permitting multiple players, or the like. Preferably, the amusement device 10A is made operable upon actuation of the input component 14A, for example, the player may only select and play an electronic game once value is received at the input component 14A and/or one or more playable credits are established by the controller U1 and issued to the player. However, free selections may be offered at the discretion of an operator of the amusement device 10A. The input component 14A may also be comprised of the touchscreen display 12A in the preferred embodiment, by permitting the player or user to input value, credits or access a player account to pay for access to the application programs. The touchscreen display 12A is also preferably utilized to select the game that the user wishes to play from the plurality of electronic games stored in the amusement device 10A.

FIG. 1B shows another or second amusement device 10B in accordance with a second preferred embodiment of the present invention. The second amusement device 10B also includes a controller U1, a memory U2, a display 12B, and an input component 14B. Preferably, the video displays 12A, 12B are touchscreen video displays configured to accept touch input, which may be utilized to input value to gain access to the application programs.

FIG. 1C shows yet another or third amusement device 10C in accordance with a third preferred embodiment of the present invention. The third amusement device 10C is preferably a portable device, preferably battery-powered, and includes a controller U1, a memory U2, a display 12C, and an input component 14C. The third amusement device 10C is preferably usable with a docking station (not shown). The docking station preferably secures the device 10C until accessed by an operator or paid for by a player. The docking station also preferably permits recharging of a battery (not shown) secured in the third preferred amusement device 10C. Release from the docking station may occur via an entry through the input component 14C, which is preferably a card reader, but may also be comprised of the touchscreen display 12C that permits potential user or player inputs to gain access to a player account having pre-loaded value therein. The docking station may also provide battery recharging and other services to the amusement device 10C.

For convenience, the amusement devices 10A, 10B, 10C of the first, second and third preferred embodiments will be referred to hereinafter simply as “amusement device 10.”

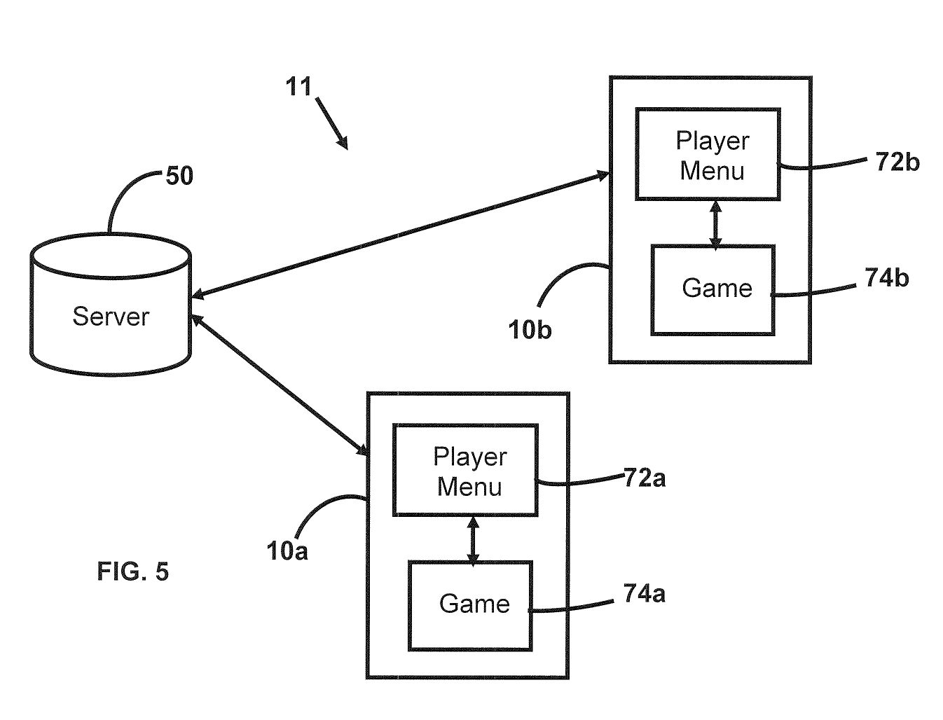

Turning now to the operation of the amusement device 10, the memory U2 stores one or more application programs, such as electronic games, a music or video jukebox program, or the like, and a system control program. However, the one or more application programs may also be stored remotely, such as on a server 50 (FIG. 5) which communicates with the amusement device 10. The controller U1 controls the touchscreen display 12 based upon the system control program retrieved from the memory U2 and based upon inputs from the touchscreen display 12. As used herein, the system control program refers to all of the software functions outside of the application program files including an operating system, display control, input control, sound drivers, and the like. Other input devices which may be connected to the amusement device 10 include a pushbutton(s), a trackball or touchpad, a mouse, a joy-stick, a foot-pedal, a voice recognition system, a keypad or keyboard, and the like. But, preferably, the input device is the touchscreen display 12.

The amusement device 10 includes an operating mode and a setup mode. When the operating mode is selected, a player or user is selectively permitted to access the application programs. When the setup mode is selected, the owner/operator is permitted to make system setup adjustments. To switch from the operating mode to the setup mode, a mode selector pushbutton (hardware not shown) is provided that is typically concealed from the players. The mode selector pushbutton may be implemented as a hidden software feature, but preferably the mode selector pushbutton is a simple pushbutton that is disposed inside a housing of the amusement device 10. In the setup mode, the owner/operator may make adjustments to the game features as will be described in greater detail hereinafter.

In the preferred embodiments of the present invention, the controller U1 controls the touchscreen display 12 based upon the system control program retrieved from the memory U2 and based upon inputs of the player or user. The touchscreen display 12 preferably has a “widescreen” aspect ratio, but is not so limited and may have nearly any variety of aspect ratio that may be customized for the type of game played on the amusement device 10 or the particularized tasks typically performed by the amusement device 10. Such ratios may include, for example, 16:9, 16:10, 1.85:1, 2.35:1, or the like. The touchscreen display 12 is also preferably configured to receive a plurality of touch inputs simultaneously, i.e., one or more players may touch the touchscreen display 12 in multiple locations, each of which is simultaneously accepted and acted upon by the amusement device 10, as if the touch inputs were separately received, but is not so limited. The touchscreen display 12 is preferably, therefore, of the projected capacitive type or the like for supporting multi-touch input.

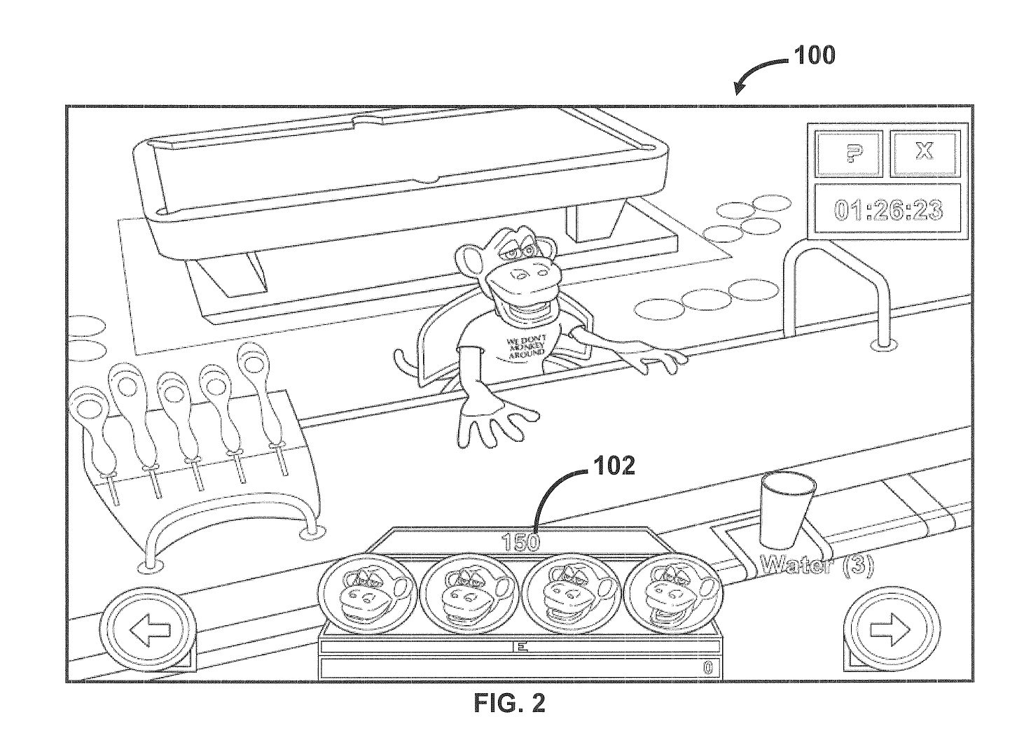

In the preferred embodiments of the present invention, the controller U1 controls the touchscreen display 12 based upon the system control program retrieved from the memory U2 and based upon inputs of the player. Alternatively, the touchscreen display 12 may be controlled by a central server 50 and the system control program may be retrieved from the central server 50. The controller U1 is preferably configured to select and play at least one of a plurality of electronic games. The selection is preferably received at the touchscreen display 12 and is input by a first player of a plurality of players. FIG. 2 shows a screenshot 100 of an example of a game that may be played on the amusement device 10. For example, a player establishes one or more playable credits by entering value into the input component 14 and/or the touchscreen display 12. By obtaining a requisite number of credits, the player or user is permitted to play the game shown in the screenshot 100. The player may play the game to score amusement points 102, to defeat another player in a head-to-head game, or achieve other goals and/or objectives specific to the selected game.

In addition, the one or more playable credits necessary to permit play are different than and not based on the amusement points. For example, the total number of amusement points are not used to award additional playable credits. However, the amusement device 10 may offer a bonus round or replay to a user for achieving a high score, a predetermined winning percentage in play of a series of head-to-head games or the like. The free bonus round differs from a playable credit in that the user does not have a choice of game or the ability to reclaim value. The bonus round is another chance to play the same game, a similar game or a specific portion of a game without having to input a playable credit. The conditions for awarding a bonus round are preferably set by an operator when the amusement device 10 is in the setup mode.

The player preferably has an established player account with a unique identifier, such as an account name, number, or the like. The player account may store detailed information about the player, the player's history of playing games on one or more amusement devices 10, prize or award history, preferences, stored value for initiating the game, stored score amusement points 102 from previous game play, stored virtual currency associated with the player and the like. Information associated with the player account is preferably stored in the server 50 connected to a network of one or more amusement devices 10, and may be retrieved for use by an amusement device 10 when the player logs in. However, the player account may also be stored in the memory U2 locally on the amusement device 10. Storing the player account on the memory U2 may be beneficial if the amusement device 10 is unable to communicate with the server 50. The player may preferably log into the player account from any amusement device 10 on the network using a predetermined pass code, biometric information, a Radio Frequency Identification (RFID) key, card key, or other conventional methods of secure entry. Preferably, the player may also log into the player account from other devices capable of connecting to the network, such as a PC, personal data assistant (PDA), smart phone, or the like for accessing at least some functionality, such as account balance review, reward redemption, player history review, stored value, stored score amusement points 102, add value, virtual currency value review, or the like.

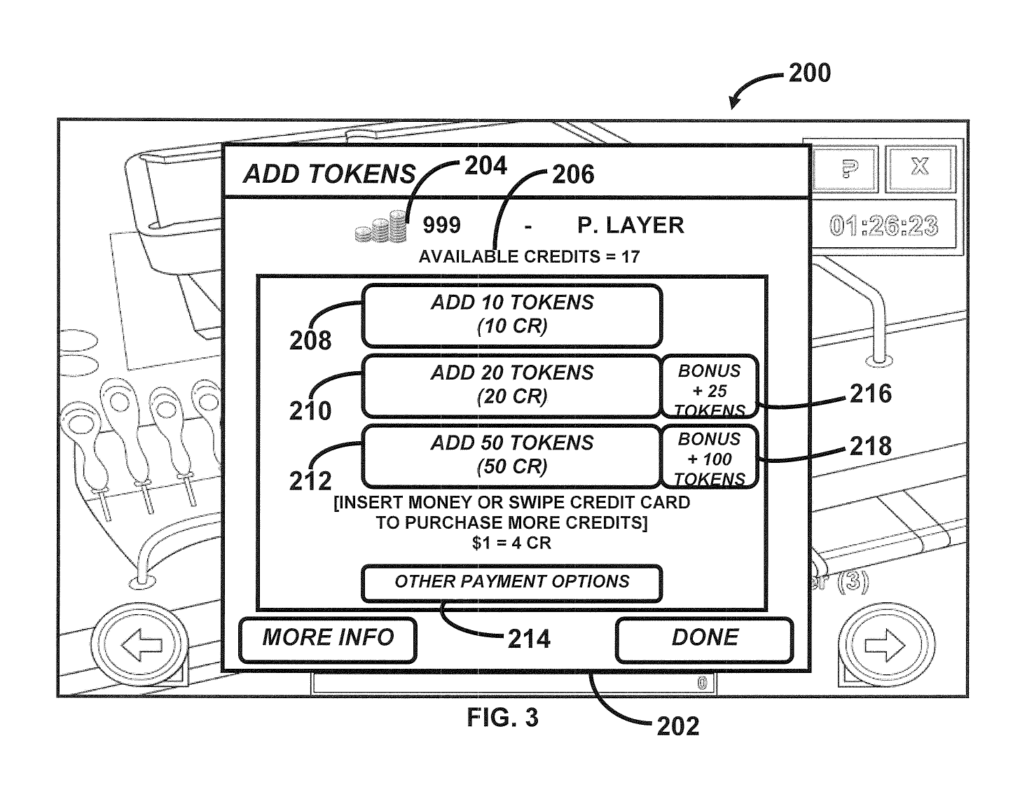

The player account also preferably has a balance of virtual currency associated therewith. The virtual currency is different than the one or more playable credits and is usable with two or more of the electronic games. Referring to FIG. 3, for example, a screenshot 200 is shown having a window 202 in which the virtual currency is referred to as “tokens.” A token indicator 204 shows that the player has a balance of nine hundred ninety-nine (999) tokens associated with the player account. A separate credit indicator 206 shows that seventeen (17) credits are available on the amusement device 10. Preferably the credits are not associated with the player account, but with the specific amusement device 10. The controller U1 is preferably configured to access the player account having the virtual currency associated therewith when the player associated with the player account initiates play of one of the electronic games. The controller U1 is preferably able to access any number of player accounts, depending upon the number of player accounts stored in the memory U2, associated with the amusement device 10 and/or the central server 50. However, in alternative embodiments, credits may travel with the player account or may be stored in the player account to be used on different amusement devices 10 that are connected to each other, preferably through the central server 50.

The player is preferably given the option to obtain additional tokens from the screenshot 200 of FIG. 3. For example, the player is provided with three selections 208, 210, 212 to purchase tokens at a cost of one (1) credit per token. The cost per token may vary as directed by one of an operator of the amusement device 10, network administrator, or the like. The one or more playable credits available in the amusement device 10 may therefore be used to purchase tokens. Alternative payment options 214 are also provided, such as currency, coins, credit/debit card transactions, electronic transfers, conversion of playable credits to virtual credits or the like. The purchased tokens are then credited to the player account. Tokens may also be credited to the player account as awards. For example, in FIG. 3, token awards 216, 218 are shown for players purchasing more than twenty (20) tokens. Tokens may also be awarded for completion of tasks by the player within certain games, completion of tasks associated with the player account or over the network, random draws, or the like.

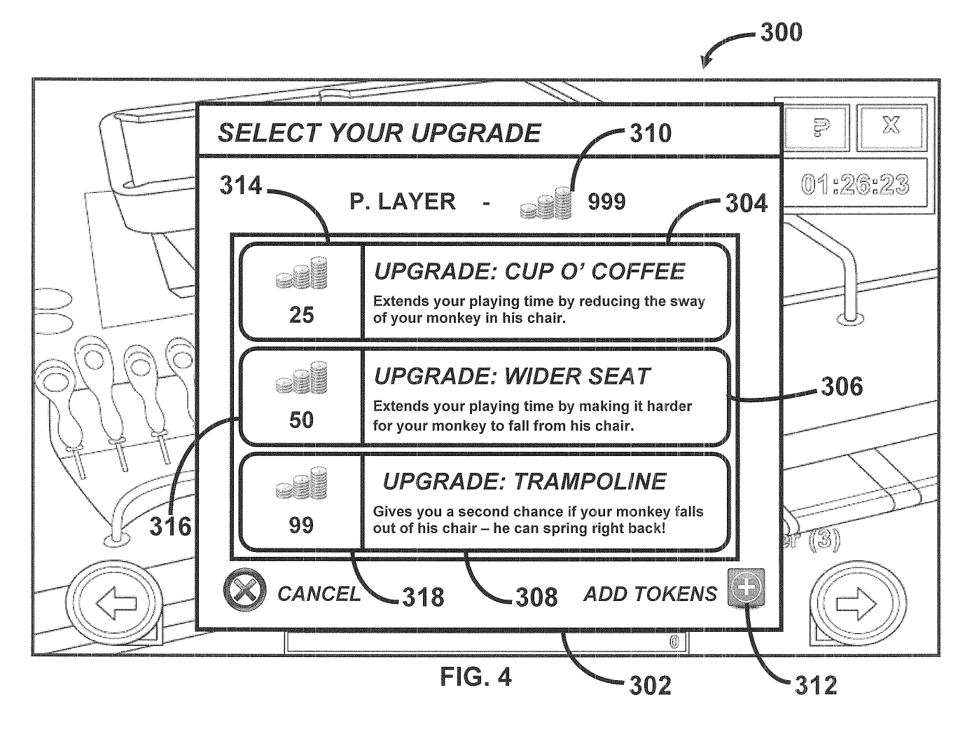

The player may exchange virtual currency for special or upgrade features, such as power-ups, upgrades, enhancements, or the like, during games. For example, FIG. 4 shows a screenshot 300 having an upgrade window 302 on the touchscreen display 12. Three (3) potential upgrade features 304, 306, 308 are presented to the player that provide the player with an advantage in the game to collect more amusement points and/or attain a higher score. However, upgrade features available in exchange for virtual currency need not necessarily have any particular functionality, and may be provided solely for entertainment purposes rather than strategic reasons. In addition, the screenshot 300 is not limited to three (3) potential upgrade features 304, 306, 308 and may show less and/or more potential upgrades. The player makes a selection of the desired upgrade feature 304, 306, 308 for use in the electronic game using the touchscreen display 12 and the controller U1 receives the selection of the particular upgrade feature 304, 306, 308. The controller U1 debits the player account by the amount of virtual currency associated with the selected upgrade feature 304, 306, 308 and the player is able to use the upgrade feature 304, 306, 308 during game play. The player is able to select any one of the upgrade features 304, 306, 308 and may select multiple upgrade features while playing a single game, depending upon the amount of virtual currency in the user's account. The amount of virtual currency required for the player to purchase or obtain the upgrade feature 304, 306, 308 may be different, depending upon which upgrade feature 304, 306, 308 the player selects. The upgrade feature 304, 306, 308 preferably provides the player with an advantage in the electronic game that is being played, allowing the player to more easily collect virtual currency for addition to the user's balance of virtual currency associated with the player's player account. The advantage may also be utilized to gain a higher score in the game being played, to complete an in-game challenge, to lower the difficulty of the game or to make the game more fun for the player. The in-game challenge is preferably related to an alternative objective for the player to complete during play of the game.

Preferably, the upgrade window 302 includes a token indicator 310, which in FIG. 4 shows that the player has an account balance of nine hundred ninety-nine (999) tokens. In addition, the upgrade window 302 includes cost indicators 314, 316, 318 displaying the respective cost, in tokens, of each of the offered upgrade features 304, 306, 308. The costs of each of the upgrade features 304, 306, 308 preferably differ, with more desirable features requiring a higher amount of virtual currency in exchange for receipt of the upgrade features 304, 306, 308. However, the costs of two (2) or more of the upgrade features 304, 306, 308 may also be identical. Further, the cost or required amount of virtual currency required to access or obtain one (1) or more of the offered upgrade features 304, 306, 308 is preferably adjustable by a network administrator, although an operator of the amusement device 10 may also have the ability to adjust the cost. When a player selects one of the offered upgrade features 304, 306, 308, the player account is debited by the amount of virtual currency corresponding to the selected offered upgrade feature 304, 306, 308.

Some of the electronic games may limit the number of features a player is allowed to acquire during gameplay. Other games may permit the player to obtain as many upgrade features as desired, with the only limitation being the amount of virtual currency associated with the player account. The upgrade window 302 also preferably provides the player with a button 312 linking to a screen, such as that shown in FIG. 3, where the player can acquire more virtual currency. The controller U1 may be configured to permit the player to purchase virtual currency in exchange for playable credits or by inputting value to the input component 14. Alternatively, the virtual currency may be provided or credited to the player account as an award based on the player's game play, such as by achieving a particular score in a high score game or winning a particular number of games in a head-to-head game.

In operation, the amusement device 10 runs, via the controller U1 and/or the central server 50, an executable player menu program 72 and a game 74 selected by the player, as shown in FIG. 5. The player menu program 72 communicates with the game 74 and also with the central or network server 50 that preferably stores the player account. Preferably, the game 74 includes the features as part of its programming, and is instructed by the player menu program 72 to enable a feature when selected and “paid for” by the player. Thus, the player menu program 72 preferably performs accounting functions for crediting/debiting the player account with virtual currency. In addition, the player menu program 72 preferably communicates transactions involving the player account in real time with the server 50. However, the player account information may be updated at the server 50 at regular intervals, after log-out of the amusement device 10, upon other types of trigger conditions, or the like.

The system may operate as an amusement device network 11 including a plurality of amusement devices 10 connected to the server 50. The plurality of amusement devices 10 preferably include at least a first amusement device 10a and a second amusement device 10b. Each of the amusement devices 10a, 10b in the amusement device network 11 preferably including a touchscreen display 12, an input component 14, a memory U2 and a controller U1. The server 50 stores a plurality of electronic games, including a first electronic game 74a and a second electronic game 74b, and a plurality of player accounts associated with players 60 of the network 11. The server 50 preferably stores more electronic games than the first and second electronic games 74a, 74b. The server 50 preferably transmits a signal to the appropriate amusement device 10a, 10b to display the player menu program 72a, 72b that is associated with the particular game 74, 74a, 74b and/or the player 60 who is logged into the amusement device network 11.

The server 50 preferably receives a signal from the amusement device 10a, 10b related to playable credits when the player inputs value into the input component 14. The playable credit permits the player to play at least one of the electronic games 74a, 74b of the plurality of electronic games. The plurality of electronic games include at least the first and second electronic games 74a, 74b and preferably more electronic games for play by the player 60. The server 50 also preferably receives, from a first player 60, a selection of one of the plurality of games, such as the first electronic game 74a, from the amusement device 10a, preferably from the touchscreen display 12. The server 50 accesses the first player account of the first player 60. The first player account preferably includes a balance of virtual currency that is different than the playable credit and is usable with two or more of the plurality of electronic games 74a, 74b. The player 60 may elect to utilize the virtual currency to utilize a first upgrade feature that is exchanged for a predetermined amount of the player's virtual currency. The first upgrade feature is preferably utilized by the first player during play of the electronic game 74a, 74b that is selected for play. The first upgrade feature provides the first player 60 with an advantage in the selected electronic game 74a, 74b to collect more virtual currency associated with the first player account. Accumulation of additional virtual currency permits the purchase of additional upgrade features and the additional virtual currency is preferably updated to the first player's account during gameplay or at the conclusion of the player's 60 gaming session. Alternatively, the advantage may be utilized to gain a higher score in the game being played, to complete an in-game challenge, to lower the difficulty of the game or to make the game more fun for the player

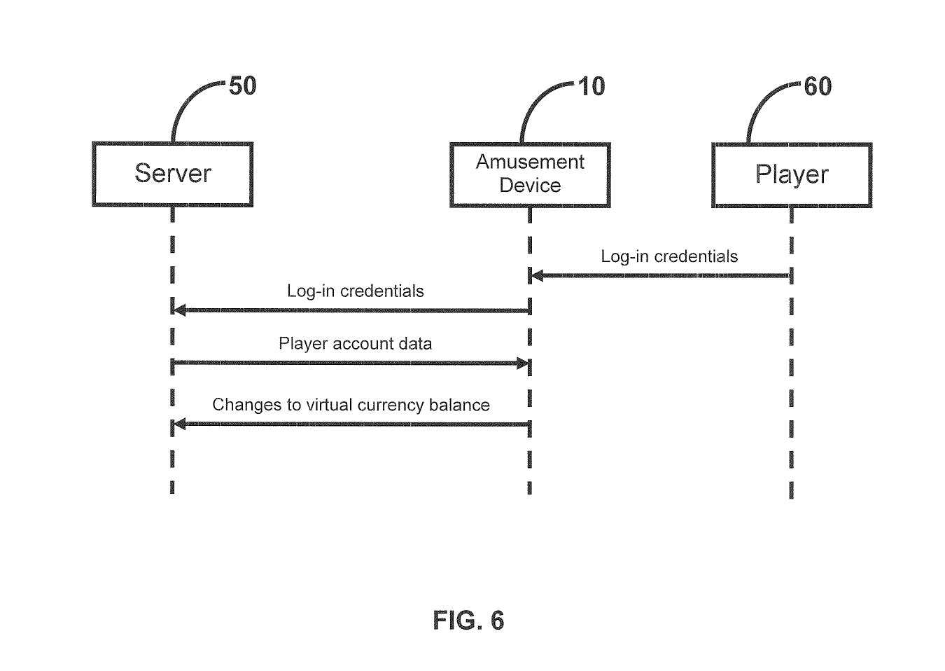

Referring to FIG. 6, a communication sequence diagram between the amusement device 10 and the server 50 for accessing the player account is shown. The player 60, which may be a first player 60, first supplies log-in credentials, such as a password or player card as described above or the like and the log-in credentials are received by the controller U1 and/or the server 50. The controller U1 and/or server 50 is prevented from accessing the player account before receipt of valid log-in information. The log-in credentials are then supplied to the central server 50 by the amusement device 10 for verification or for initial review of the player account. Once the player 60 has been verified, the central server 50 sends the player account information, including the virtual currency balance, to the amusement device 10 or communicates to the amusement device 10 that the player account is verified. The verification is made by the controller U1 and/or the server 50 by comparing at least the first player password to a stored first player password that is stored in the first player account. The server 50 preferably compares the first player password to stored passwords of the plurality of players and player accounts to verify which player account is associated with the request. The server 50 is not limited to comparing only password information from the first player to the plurality of player accounts and may compare a player identifier and password information, information from a player or user card or any variety of information from the player 60 to assist in identifying the appropriate player account that is requested from the server 50 and/or the memory U2. Any changes to the virtual currency account balance, such as credits or debits to the account made by the player during play, are sent back to the server 50 to update the player account.

The central server 50 is capable of storing multiple player accounts and virtual currency balances associated with each. It is contemplated that more than one player may log-in to one of a plurality of the amusement devices 10 at one time in order to play games in head-to-head, tournament, cooperative, or other multi-player modes. Accordingly, player account information and respective virtual currency balances for each player with a verified log-in will be sent to the amusement device 10 from the central server 50.

The amusement device 10 may also include other functionality and features such as music jukebox, video jukebox, multimedia player, Internet browsing, broadcast media viewing, time based rental mode, non-prize tournaments, prize-based tournaments, head-to-head competitions, prize-based lotteries, ticket dispensing, prize dispensing, debit/credit card charging, phone card dispensing, e-mail, photography, placing customer orders, communicating with other amusement devices, and the like.

The amusement device 10 may also provide for remote or local access for accounting and/or bookkeeping purposes. The amusement device 10 may include a local connector for uploading to a hand-held or portable computer or removable memory for receiving accounting or other data. The amusement device 10 may include accounting and bookkeeping screens accessible by an operator through set up screens and/or through password protection.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An amusement device comprising:
(a) a touchscreen display;
(b) an input component that receives value in order to establish a playable credit, the playable credit being used to permit play of at least one of a plurality of electronic games; and
(c) a controller configured to:
(i) receive, via the touchscreen display, a selection of at least one of the plurality of electronic games,
(ii) access a first player account, via a memory, having a balance of virtual currency associated therewith, the virtual currency being different than the playable credit and usable with two or more of the plurality of electronic games,
(iii) send a signal to the touchscreen display to display a first upgrade feature and a second upgrade feature on the touchscreen display,
(iv) receive a selection of the first upgrade feature from the touchscreen display, and
(v) debit, via the memory, the first player account by a first amount of virtual currency in exchange for use of the first upgrade feature during play of the at least one electronic game, wherein the first and second upgrade features provide a first player associated with the first player account with an advantage in the at least one of the plurality of electronic games.

2. The amusement device of claim 1, wherein the controller displays, on the touchscreen display, an upgrade window offering the first and second upgrade features to the first player.

3. The amusement device of claim 2, wherein the controller is configured to receive a selection of the second upgrade feature from the touchscreen display and debit the first player account by a second amount of virtual currency in exchange for use of the second upgrade feature during play of the at least one of the plurality of electronic games.

4. The amusement device of claim 3, wherein the first amount of virtual currency and the second amount of virtual currency are different.

5. The amusement device of claim 1, wherein the controller is further configured to credit the first player account by a third amount of virtual currency.

6. The amusement device of claim 5, wherein the third amount of virtual currency is provided to the first player in exchange for at least one of playable credits and value.

7. The amusement device of claim 5, wherein the third amount of virtual currency is provided to the first player as an award based on play of the at least one of the plurality of electronic games.

8. The amusement device of claim 1, wherein the controller is configured to access additional player accounts having respective balances of virtual currency associated therewith.

9. The amusement device of claim 1, wherein the controller is further configured to display, on the touchscreen display, a third upgrade feature, receive a selection of the third upgrade feature from the touchscreen display and debit the first player account by a fourth amount of virtual currency in exchange for use by the first player of the third upgrade feature during play of at least one other of the plurality of electronic games.

10. The amusement device of claim 1, wherein the first amount of virtual currency is adjustable.

11. The amusement device of claim 1, wherein the controller is further configured to receive log-in information from the first player, the controller being prevented from accessing the first player account before receipt of the log-in information.

12. The amusement device of claim 1, wherein the advantage is utilized to collect more virtual currency for the balance of virtual currency associated with the first player account.

13. The amusement device of claim 1, wherein the advantage is utilized to at least one of gain a higher score when playing the at least one of the plurality of games, to complete an in-game challenge, to lower the difficulty of the game and to make the at least one of the plurality of the games more fun.

14. A method of playing an amusement device, wherein the amusement device includes a touchscreen display, an input component, a memory and a controller, the memory storing a plurality of electronic games, the method comprising:
(a) receiving, by the input component, value and establishing, by the controller, a playable credit based on the value, the playable credit being used to permit play of at least one of the plurality of electronic games;
(b) selecting and playing, by the touchscreen display, the at least one of the plurality of electronic games;
(b) accessing a first player account, by the memory, having a balance of virtual currency associated therewith, the virtual currency being different than the playable credit and usable with two or more of the plurality of electronic games; and
(c) debiting, at the memory, the first player account by a first amount of virtual currency in exchange for use by a first player associated with the first player account of a first upgrade feature during play of the at least one of the plurality of electronic games, wherein the first upgrade feature provides the first player with an advantage in the at least one of the plurality of electronic games to collect more virtual currency for the balance of virtual currency associated with the first player account.

15. The method of claim 14, further comprising:
(d) displaying, on the touchscreen display, an upgrade window offering the first upgrade feature to the first player.

16. The method of claim 15, wherein the upgrade window includes a second upgrade feature for use by the player during play of the at least one electronic game, the second upgrade feature being exchangeable for a second amount of virtual currency.

17. The method of claim 14, further comprising:
(d) crediting, at the memory, the first player account by a second amount of virtual currency.

18. The method of claim 14, further comprising:
(d) debiting, at the memory, the first player account by a second amount of virtual currency in exchange for use by the first player of a second upgrade feature during play of at least one other of the plurality of electronic games.

19. The method of claim 14, further comprising:
(d) receiving, by the touchscreen display, log-in information from the first user prior to accessing the first player account, wherein the first player account is associated with the first player.

20. A method of playing an electronic game on an amusement device network, wherein the amusement device network includes a plurality of amusement devices connected to a server, each of the plurality of amusement devices includes a touchscreen display, an input component, a memory and a controller, the server storing a plurality of electronic games and a plurality of player accounts, the method comprising:
(a) receiving, via the server from the input component of one of the plurality of amusement devices, value and establishing, by the server, a playable credit based on the value, the playable credit being used to permit play of at least one of the plurality of electronic games;
(b) receiving, via the server, a selection of at least one of the plurality of electronic games from at least one of the plurality of amusement devices;
(b) accessing a first player account of the plurality of player accounts associated with a first player, by the server, having a balance of virtual currency associated therewith, the virtual currency being different than the playable credit and usable with two or more of the plurality of electronic games; and
(c) debiting, at the server, the first player account by a first amount of virtual currency in exchange for use by the first player of a first upgrade feature during play of the at least one of the plurality of electronic games, wherein the first upgrade feature provides the first player with an advantage in the at least one of the plurality of electronic games.

21. The amusement device network of claim 20, further comprising:
(d) receiving, via the server from the one of the plurality of amusement devices, log-in credentials including a first player password; and
(e) verifying, via the server, the first player password by comparing the first player password to a stored first player password.

22. The amusement device network of claim 21, further comprising:
(f) transmitting, via the server, the first player account to the one of the plurality of amusement devices, the first player account being stored in the memory of the one of the plurality of amusement devices; and
(g) receiving, via the server, updated first player account information when the first player completes play of the one of the plurality of electronic games.
